(19) United States
(12) Patent Application Publication
(10) Pub. No.: US 2006/0204709 A1
(43) Pub. Date: Sep. 14, 2006

(54) HOUSING FOR A PORTABLE DEVICE, AND METHOD FOR MAKING THE SAME

(75) Inventor: SHENG-HSI CHEN, TUCHENG (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/307,747

(22) Filed: Feb. 20, 2006

(30) Foreign Application Priority Data
Mar. 11, 2005 (CN) 200510033623.X

(51) Int. Cl. B32B 3/02

(52) U.S. Cl. 428/68

(57) ABSTRACT

A housing (1) for a portable electronic device includes a molded substrate (10), an ultraviolet light detecting film (20), and a transparent protective film (30). The ultraviolet light detecting film is formed on the substrate, and the transparent protective film is formed on the ultraviolet light detecting film. The ultraviolet light detecting film comprises an ultraviolet photochromic material. The molded substrate is made of a material of plastic or metal. The ultraviolet light detecting film is formed on all or part of the surface of the substrate.

### FIELD OF THE INVENTION

The present invention generally relates to portable devices and, more particularly, to a housing for a portable device and a method for making the housing.

### DESCRIPTION OF RELATED ART

Ultraviolet (UV) rays in sunshine can cause skin atrophy and dermal cancer. Short wave ultraviolet can damage the skin, and long wave ultraviolet can brown the skin. With the continued destruction of the ozone layer of the atmosphere, more and more UV rays will penetrate our atmosphere.

The influence of UV light on human skin begins from a person's birth. When the damage from ultraviolet light accumulates to a certain degree, skin may atrophy. If a person has been badly damaged by ultraviolet during childhood, the probability of dermal cancer increases by 100%. However, if a person avoids excess UV light exposure, there is a 78% per chance they will not fall victim to dermal cancer. Therefore, persons often use sunscreen products according to weather conditions when outdoors. However, sudden changes in weather can catch people unprepared.

Now, with the development of information technology, portable devices such as notebook computers, mobile phones, and personal digital assistants (PDAs) have become very popular. If a portable device were to have a function of detecting ultraviolet light, it would alert those who are concerned about the health of their skin to take precautions when they are being exposed to too much UV light.

Therefore, a portable device, which has a function of detecting ultraviolet light, is desired.

### SUMMARY OF INVENTION

In one embodiment thereof, a housing for a portable device includes a molded substrate, an ultraviolet detecting film, and a transparent protective film. The ultraviolet light detecting film is formed on the substrate, and the transparent protective film is formed on the UV light detecting film. The UV light detecting film comprises an ultraviolet photochromic material. The molded substrate is made of plastic or metal. The UV light detecting film is formed on all or part of the surface of the substrate.

A method for making a housing for a portable device includes the steps of: molding a substrate; forming an ultraviolet light detecting film on the substrate; and forming a transparent protective film on the ultraviolet light detecting film.

Other advantages and novel features will become more apparent from the following detailed description when taken in conjunction with the accompanying drawings.

### BRIEF DESCRIPTION OF DRAWINGS

Many aspects of the housing can be better understood with reference to the following drawings. The components in the drawings are not necessarily to scale, the emphasis instead being placed upon clearly illustrating the principles of the present housing. Moreover, in the drawings, like reference numerals designate corresponding parts throughout the several views.

FIG. 1 is a schematic view of a housing in accordance with a preferred embodiment; and

FIG. 2 is a cross-sectional view of the housing along line II-II in FIG. 1.

### DETAILED DESCRIPTION

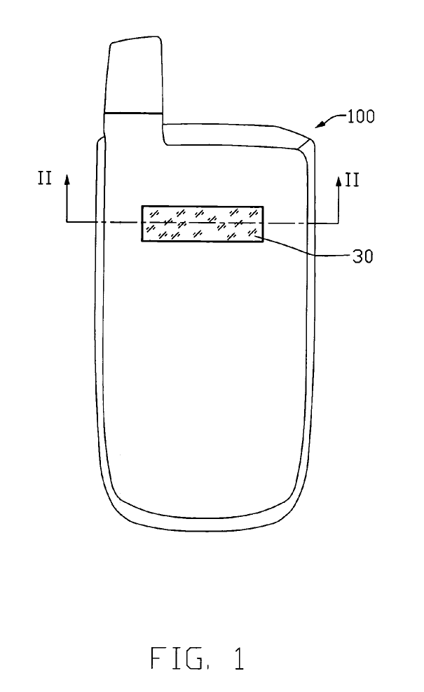

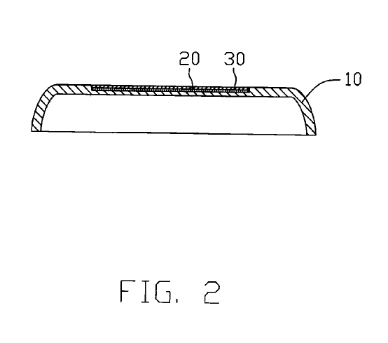

Referring to FIGS. 1 and 2, in a preferred embodiment, a housing 100 for a portable electronic device includes a molded substrate 10, an ultraviolet (UV) light detecting film 20, and a transparent protective film 30. The molded substrate 10 can be a front cover, back cover, slip cover, flip cover, or slide cover of a portable electronic device. The molded substrate 10 is, advantageously, made of a plastic material or a metal material. The UV light detecting film 20 is formed on a surface of the molded substrate 10, and the transparent protective film 30 is formed on a surface of the UV light detecting film 20 for protecting the UV light detecting film 20. The UV light detecting film 20 can be formed on all of the substrate, or part of the substrate. The UV light detecting film 20 is made of an ultraviolet photochromic material. The transparent protective film 30 is made of a transparent plastic material, such as polycarbonate, and polymethyl methacrylate.

When using a portable electronic device with the housing 100, the ultraviolet photochromic material of the UV light detecting film 20 will be of a color according to the intensity of ultraviolet light the device is being exposed to. The color will readily change according to the variations in the intensity of the ultraviolet light striking the UV light detecting film 20. Accordingly, the user of the portable electronic device can choose an appropriate measure of protection such as choosing a sunscreen or sun block of the appropriate sun protection factor (SPF).

The UV light detecting film 20 can have a color key area for showing the intensity of the ultraviolet light exposure associated with each color. For example, the color key area may be demarcated into a secure zone and a warning zone according to appropriate levels of intensity of ultraviolet light that might be considered safe or unsafe for peoples' skin. If the color key indicates the intensity of the UV light is in the secure zone, the user need not take extra precautions for skin protection. If the color key indicates the intensity of the UV light is in the warning zone, the user should consider taking precautions to protect their skin.

A method for making the housing 100 for the portable electronic device includes the steps of: (1) molding a substrate 10, when the material of the substrate 10 is plastic, the substrate 10 being molded by a method of injection molding, when the material of the substrate 10 is metal, the substrate 10 being molded by a method of stamping molding; (2) forming an UV detecting film 20 on all or part of a surface of the substrate 10, the ultraviolet light detecting film 20 being made of an ultraviolet photochromic material, and the UV light detecting film 20 being formed on the substrate 10 by a method of coating, heat transfer, water transfer, or silk-screen printing; (3) forming a transparent protective film 30 on a surface of the UV light detecting film 20, the transparent protective film 30 can also be formed on the surface of the substrate 10 if the UV light detecting film 20 is formed on part of the surface of the substrate 10, the transparent protective film 30 being made of a transparent plastic material, such as polycarbonate or polymethyl methacrylate; thereby obtaining a housing 100 for a portable electronic device.

It is understood that the housing 100 for portable electronic devices can also be used for other portable devices, such as a watch, a portable bag, and so on.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A housing for a portable device, comprising:
a molded substrate;
an ultraviolet light detecting film formed on the substrate; and
a transparent protective film formed on the ultraviolet light detecting film;
wherein the ultraviolet light detecting film comprises an ultraviolet photochromic material.

2. The housing as claimed in claim 1, wherein the molded substrate is made of a plastic material.

3. The housing as claimed in claim 1, wherein the molded substrate is made of a metal material.

4. The housing as claimed in claim 1, wherein the ultraviolet light detecting film is formed on all or part of the surface of the substrate.

5. The housing as claimed in claim 1, wherein the ultraviolet light detecting film has a color key area showing the intensity of detected ultraviolet light.

6. The housing as claimed in claim 1, wherein the portable device is a portable electronic device.

7. A method for making a housing for a portable device, comprising the steps of:
molding a substrate;
forming an ultraviolet detecting film on the substrate; and
forming a transparent protective film on the ultraviolet detecting film.

8. The method as claimed in claim 7, wherein the substrate is made of a plastic material.

9. The method as claimed in claim 8, wherein the substrate is molded by means of injection molding.

10. The method as claimed in claim 7, wherein the substrate is made of a metal material.

11. The method as claimed in claim 10, wherein the substrate is molded by means of stamping molding.

12. The method as claimed in claim 7, wherein the ultraviolet light detecting film is formed on the substrate by a method selected from the group consisting of coating, heat transfer, water transfer, and silk-screen printing.

13. A portable device, comprising:
an ultraviolet light detecting housing, comprising:
a substrate; and
an ultraviolet light detecting structure formed with the substrate, the ultraviolet light detecting structure being made of ultraviolet photochromic material.

14. The portable device of claim 13, the ultraviolet light detecting housing further comprising a protective structure covering the ultraviolet light detecting structure.

15. The portable device of claim 14, wherein at least a portion of the protective structure is transparent.
